(19) United States
(12) Patent Application Publication
(10) Pub. No.: US 2006/0108276 A1
(43) Pub. Date: May 25, 2006

(54) Cartridge filter system with lift tube

(76) Inventors: Harold H. Harms, Palm Beach Gardens, FL (US); Eric D. Seville, Hobe Sound, FL (US)

Correspondence Address: AKERMAN SENTERFITT, P.O. BOX 3188, WEST PALM BEACH, FL, 33402-3188, US

(21) Appl. No.: 10/997,588

(22) Filed: Nov. 24, 2004

(51) Int. Cl. B01D 25/00

(52) U.S. Cl. 210/323.2; 210/257.1; 210/232; 210/237; 210/451; 210/445

(57) ABSTRACT

A fluid filter system with cartridge filters housed in a tank in which each cartridge filter has a lift tube positioned concentrically within each cartridge filter. The lift tubes extend from a support plate, which divides the tank into a raw fluid chamber and a processed fluid chamber, toward a tank cover. The lift tubes have inlet ports proximate to the tank cover so that the fluid surface in the tank is maintained at or near an upper end of the cartridge filters. This configuration enables the lift tubes to exhaust excess air in the tank through the lift tubes and out of the filter system through outlet ports in the processed fluid chamber. By exhausting air from the filter system, the capacity of the system is not compromised by the air and the expected life of the cartridge filters is not reduced.

### FIELD OF THE INVENTION

This invention is directed generally to fluid filters, and more particularly to fluid filters having replaceable filters.

### BACKGROUND

There exists numerous conventional fluid filters for removing contaminants, such as shown in U.S. Pat. Nos. 3,720,322 and 4,187,179. One particular style of fluid filter, such as those used in drinking water and pool cleaning systems, includes a generally cylindrical tank housing a removable cartridge filter, as shown in U.S. Pat. Nos. 4,561,979 and 5,316,677. A conventional cartridge filter is often formed from a filter media positioned between bottom and top plates. Fluids are filtered by passing the fluids into the tank, passing the fluids through the filter media, and expelling the filtered fluids through an outlet tube in the cartridge filter.

One conventional filter system, as shown in FIG. 1, includes a plurality of filter cartridges positioned longitudinally within a tank and concentrically about supports extending from a bottom plate toward the tank cover. The filter system is configured such that raw fluids enter the system and pass through the filter cartridge, whereby contaminants are removed from the fluid. The processed fluids collect in hollow central cores within the cartridge filters and flow from the hollow cores through an outlet port in the tank. As shown in FIG. 1, the supports have cross-sections that resemble angle iron, such that at least a portion of each support is open along its length. The supports have openings that extend from end to end. The elongated openings in the supports enable processed fluids to flow into the support at any level in the raw fluid chamber. During operation, air builds up in the tank and is not exhausted through the elongated opening in the support because air is prevented from entering the outlet ports by the fluids contained in the central core of the cartridge filters. As a result, air accumulates in the tank and upper portions of the cartridge filters that are exposed to the air are unused. The accumulation of air in the tank reduces the capacity of the filter system and reduces the useful life of the cartridge filters. Thus, a need exists for an inexpensive filter system capable of using a variety of filter cartridges and capable of automatically bleeding air from the filter system.

### SUMMARY OF THE INVENTION

This invention is directed to a filter system for removing contaminants or other materials from a fluid, such as water. The filter system is formed from a tank divided into a raw fluid chamber and a processed fluid chamber and having one or more cartridge filters. Each cartridge filter is positioned concentrically around a lifting tube extending from a support plate into the raw fluid chamber. The lift tubes may include inlet ports positioned in the lifting tube in close proximity to an upper end of the cartridge. This configuration of lifting tubes enables the fluid level in the tank to be maintained at the height of the upper end of the cartridge filters, thereby enabling substantially all of the surface area of the cartridge filters to be used during operation of the filter system. Excess air entering the system may be expelled from the system through the lift tube.

filter system includes a tank separated by a support plate into a raw fluid chamber and a processed fluid chamber. The raw fluid chamber of the tank may be configured to receive at least one cartridge filter. The tank may include an inlet port in the raw fluid chamber for receiving raw fluids and an outlet port in the processed fluid chamber for expelling processed fluids. The filter system also includes one or more lift tubes releasably attached to the support plate and extending toward a tank cover that seals the raw fluid chamber. The lift tube may include an inlet port proximate to the cover of the tank. Cartridge filters are positioned in the raw fluid chamber generally concentrically with the lift tubes such that the lift tubes are positioned in a hollow core of the cartridge filters. Each lift tube may have one or a plurality of cartridge filters positioned generally concentrically with the lift tube such that fluids flowing through the inlet port in the tank pass though the cartridge filter, flow toward the cover, pass through the inlet port in the lift tube proximate to the cover, and are collected in the processed fluid chamber.

The lift tube of the filter system regulates the fluid level in the raw fluid chamber and may be releasably coupled to the support plate. The lift tube may include a protrusion extending from an outer surface of the lift tube. The protrusion may serve numerous purposes. In at least one embodiment, the protrusion may be a collar and assist in sealing the lift tube to the support plate. The protrusion may also extend a sufficient distance from the lift tube such that the protrusion may contact the cartridge filter so that the cartridge filter may be removed from the tank by withdrawing the lift tube. The protrusion may also position the lift tube within an aperture in the support plate at a proper height.

In at least one embodiment, the cartridge filters may be sealed within the raw fluid chamber with a cartridge sealing plate. The cartridge sealing plate may be releasably coupled to a rod such that the cartridge filters may be sealed between the cartridge sealing plate, which may be proximate to the tank cover, and the support plate. The cartridge sealing plate may include one or more plugs corresponding to the cartridge filters. The plugs may include a collar for sealing a cartridge filter to a cartridge sealing plate and a dome configured to extend into the hollow core of the cartridge filter for positioning the cartridge sealing plate relative to the cartridge filter.

During operation, fluids flow into the filter system through the inlet port in the tank and collect in the raw fluid chamber. The fluids fill the raw fluid chamber and pass through the filter cartridge and into the inner hollow core of each cartridge filter in the tank. The membrane forming the filter cartridge removes materials from the fluid and allows at least a portion of the fluid to pass through the membrane. The type of materials removed from the fluid by the membrane may vary depending on the type of membrane used. After the fluids have reached the height of the inlet port of the lift tube, the fluids and excess air flow into the lift tube and collect in the processed fluid chamber. The processed fluids may be expelled from the tank through the outlet port.

An advantage of this invention is that the lift tubes enable the tank to automatically expel excess air from the system, thereby enabling fluids to contact substantially all, if not all, of the cartridge filters. By preventing the buildup of air in the system, the capacity of the filter system is not reduced, and the useful life of the cartridge filters contained in the tank are not reduced.

Another advantage of this invention is that the lift tubes are removable and capable of being used to pull cartridge filters from the tank, thereby resulting in large time savings in comparison to conventional filter systems in which lift tubes are manually withdrawn without the assistance of the lift tubes.

Yet another advantage of this invention is that the lift tubes enable the cartridge filters to removed individually and easily replaced in contrast to conventional cluster designed chambers in which all of the cartridge filters in a tank are removed at once then necessitating a time consuming process of disassembly, cartridge filter replacement, and reassembly.

Another advantage of the invention is that the cartridge filter positioning plate may be used to seal the cartridge filters at various heights in the tank, thereby enabling cartridge filters with varying heights and sizes to be used without having to resize the tank.

These and other embodiments and advantages are described below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is an exploded perspective view of a conventional fluid filter system.

FIG. 2 is an exploded perspective view depicting aspects of the fluid filter system of this invention.

FIG. 3 is a cross-sectional, assembled view of the fluid filter system shown in FIG. 2.

FIG. 4 is a perspective view of a cartridge sealing plate of this invention.

FIG. 5 is a detail view of the connection between the cartridge sealing plate and a cartridge, as shown in FIG. 3 at detail line 5-5.

FIG. 6 is a detail view of the lift tube inserted into the adapter in the support plate, as shown in FIG. 3 at detail line 6-6.

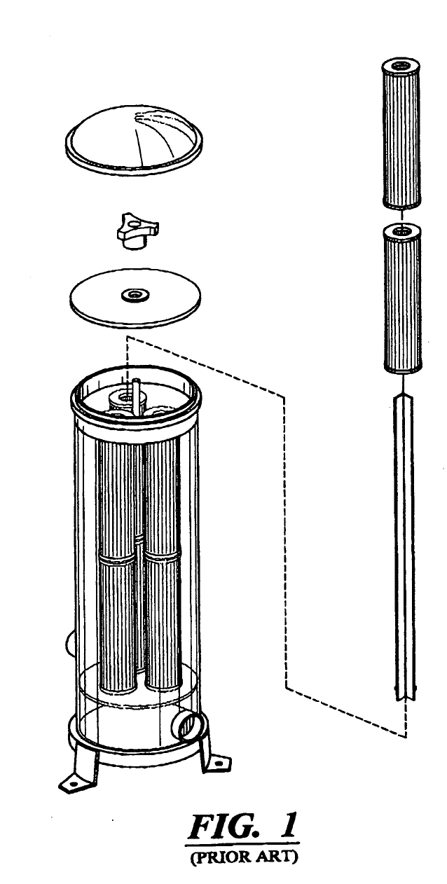

### DETAILED DESCRIPTION OF THE INVENTION

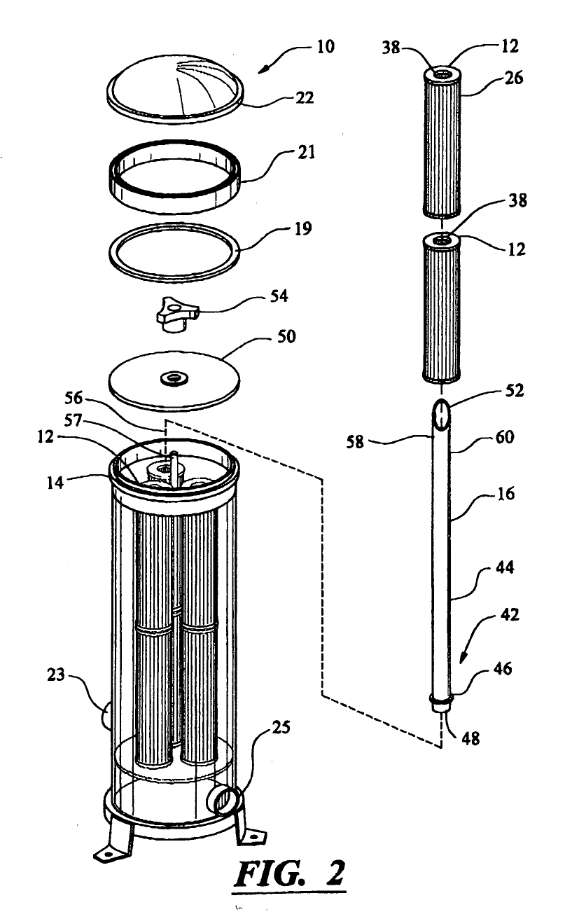

As shown in FIGS. 2-6, this invention is directed to a filter system 10 having one or a plurality of cartridge filters 12 positioned within a tank 14 for removing a variety of materials from a fluid that is passed through the filter system 10. The tank 14 includes a lift tube 16 positioned within each cartridge filter 12 that extends from a bottom surface 18 of a raw fluid chamber 20 of the tank 14. The height of the lift tube 16 establishes the height of the fluid contained within the tank 14 during operation. Air that builds up within the tank 14 in a volume exceeding the space between a tank cover 22 and an upper surface of fluid 24 at the height of the lift tube 16 is exhausted from the tank 14 through the lift tube 16. By establishing a lift tube 16 height proximate to an upper end 26 of the cartridge filter 12, air is prevented from accumulating in the tank below the height of the lift tube 16. As a result, substantially all of the surface area of the cartridge filter 12 is used during operation as fluids are passed through the filter 12.

The filter system 10 may include a tank 14 for containing cartridge filters 12. The tank 14 may be substantially cylindrical or be formed from other appropriate shapes. The capacity of the tank 14 may vary depending on the anticipated flow rate and application. The tank 14 may be formed from non-corrosive materials such as, but not limited to, stainless steel, or other appropriate materials to increase the life of the tank. The tank 14 may be sealed using tank cover 22, o-ring 19, and retention ring 21. The tank 14 may be divided into a raw fluid chamber 20 and a processed fluid chamber 28. In at least one embodiment the raw fluid chamber 20 is positioned above the processed fluid chamber 28, and the chambers 20 and 28 are separated by a support plate 30. The tank 14 may include an inlet port 23 positioned proximate to the support plate 30 for supplying raw fluids to the filter system 10. The tank 14 may also include an outlet port 25 in the processed fluid chamber 28 for expelling processed fluids from the filter system 10.

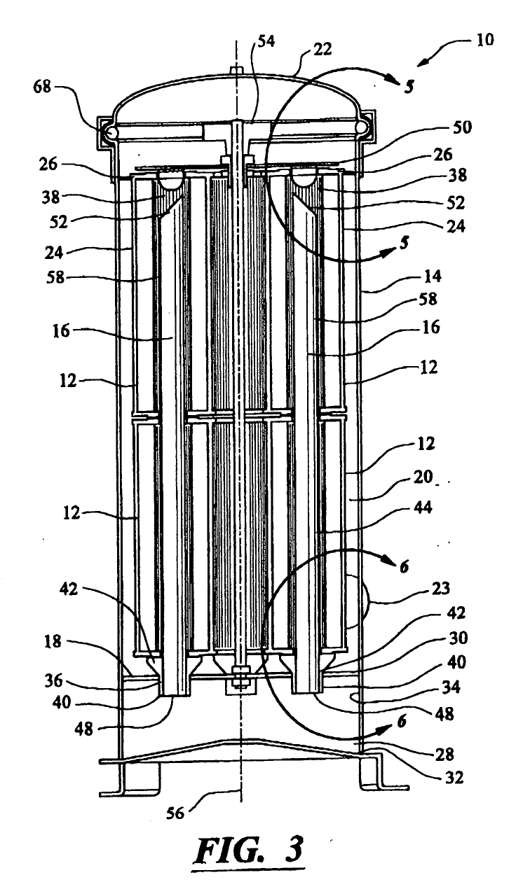

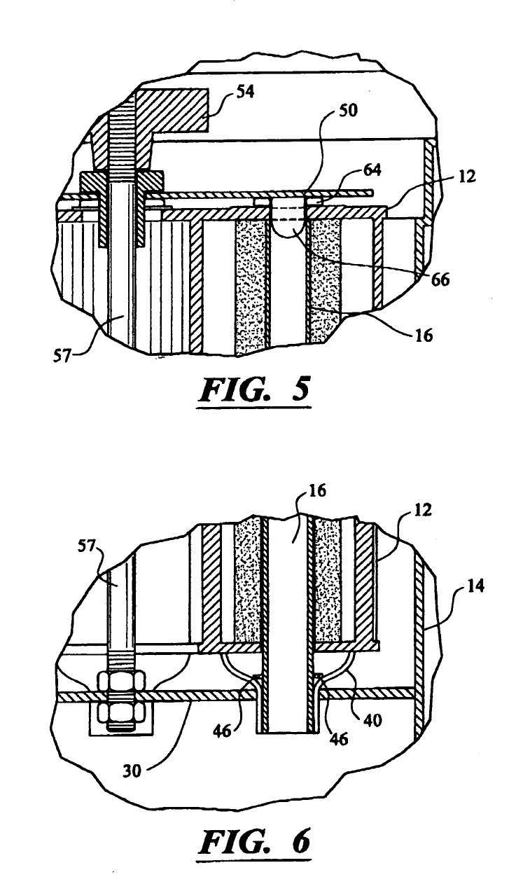

As shown in FIG. 3, the support plate 30 may be positioned proximate to a bottom end 32 of the tank 14 and positioned within the tank 14 so that the raw fluid chamber 20 may contain the cartridge filters 12. The support plate 30 may be coupled to an inner surface 34 of the tank 14 using welds or other mechanical attachment devices. The support plate 30 includes a plurality of apertures 36 for directing processed fluids from inner aspects of cartridge filters 12 to the processed fluid chamber 28. The apertures 36 may be any appropriate size, and in at least one embodiment, may be sized slightly smaller than an inner hollow core diameter 38 of the cartridge filter 12. The apertures 36 are also sized to accommodate a lift tube 16, and in at least one embodiment, an adapter 40. The adapter 40 is sized to fit within the aperture 36 and to provide a seal between the lift tube 16 and the support plate 30, as shown in FIG. 6. In at least one embodiment, the adapter 40 may be bell shaped and permanently attached to the support plate 30; however, the adapter 40 may have other appropriate shapes and be attached to the support plate 30 using other mechanisms. The lift tube 16 may be releasably positioned within the adapter 40 by inserting the lift tube 16 into the adapter 40.

The lift tube 16 may also include a one or more protrusions 42 extending from an outer surface 44 of the lift tube 16. The protrusions 42 may be configured to engage the cartridge filter 12 when the lift tube 16 is removed from the tank 14 so that the lift tube 16 may be used to remove the cartridge filter 12 from the tank 14. The protrusion 42 may also be used to form a seal between the lift tube 16 and the adapter 40 or the support plate 30. In at least one embodiment, as shown in FIG. 2, the protrusion 42 is formed from a collar 46 extending around an outer surface 44 of the lift tube 16 proximate to a lower end 48.

The lift tube 16 may extend, when installed in the tank 14, from the support plate 30 toward the tank cover 22. The height of the lift tube 16 establishes the height of the fluid contained within the raw fluid chamber 20 outside of the cartridge filters 12. In at least one embodiment, the lift tube 16 may extend from the support plate 30 and terminate in close proximity to the tank cover 22. In particular, the lift tube 16 may terminate in close proximity to a cartridge sealing plate 50, as shown in FIG. 5. In these embodiments, fluids passing through the filter cartridge 12 must first reach the height of the inlet port 52 in the lift tube 16 before passing into the processed fluid chamber 28. Thus, the volume of air may be maintained at a level such that substantially all, if not all, of the cartridge filter 12 is used during operation, rather than just a lower portion, as is the case when a large volume of air is present in the tank 14.

In the embodiment depicted in FIG. 2, four lift tubes 16 extend from the support plate 30 and terminate proximate to the cartridge sealing plate 50. Each lift tube 16 may accommodate one or more cartridge filters 12. As shown in FIGS. 2 and 3, each lift tube 16 may have two cartridge filters 12 positioned concentrically around the lift tube 16. Thus, in this embodiment, eight cartridge filters 12 may be contained in the tank 14. The cartridge filters 12 may be sealed against the support plate 30 using the cartridge sealing plate 50, as shown in FIG. 5. The cartridge sealing plate 50 may be releasably compressed against the cartridge filters 12 by tightening a mechanical connector 54, such as, but not limited to, a nut or other appropriate device on a rod 57. In at least one embodiment, the rod 57 may extend the length of the tank 14 generally along a longitudinal axis 56 of the tank 14. When the cartridge sealing plate 50 is compressed against the cartridge filters 12, fluids are not capable of entering the inlet port 52 of the lift tube 16 without first passing through the filter cartridge 12.

The cartridge filters 12 may include filter media for removing any number of materials, chemicals, contaminants, and the like from the fluids passed through the filter system 10. The cartridge filters 12 may be, but are not limited to being, activated carbon filters, sedimentary filters, submicron filters, and other appropriate filters depending on the fluid desired to be removed from a fluid by the filter system 12. The configuration of the tank 14 and the ability of the cartridge sealing plate 50 to be releasably secured within the tank 14 at varying heights enables the filter system 10 to accommodate cartridge filters 12 having various heights. Thus, the filter system 10 may use many different sized conventional filter cartridges 12 or custom sized filter cartridges without having to adjust the size of the tank 14.

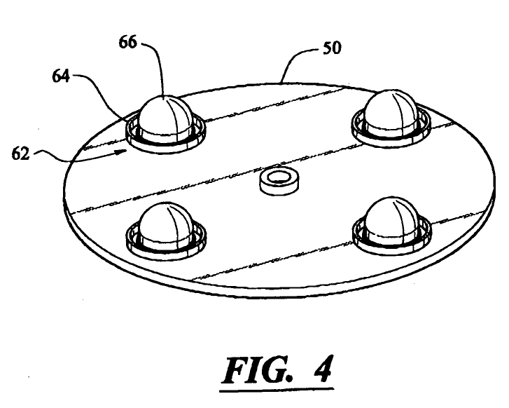

The cartridge sealing plate 50 used to seal the cartridge filters 12 may include one or more plugs 62 for sealing the upper ends 26 of the cartridge filters 12. In at least one embodiment, as shown in FIG. 4, the cartridge sealing plate 50 may include four plugs 62 positioned generally equidistant from a center point on the plate 50 and each other. In other embodiments, the cartridge sealing plate 50 may include other numbers of plugs 62 and have plugs in alternative positions on the plate 50. The plug 62 may include a collar 64 with a diameter larger than the inner hollow core diameter 38 of the cartridge filter 12. The collar 64 may be configured from a lip of the metal forming the plug 62. The collar 64 is configured to form a seal against the upper end 26 of the cartridge filter 12. The plug 62 may also include a dome 66 protruding from the plug 62 and sized to fit in the inner hollow core of the cartridge filter 12.

In an alternative embodiment, the inlet port 52 of the lift tube 16 need not be positioned on an upper end 58 of the lift tube 16. Rather, the inlet port 52 may be positioned in an outer wall 60 forming the lift tube 16. The inlet port 52 may be positioned in the lift tube 16 proximate to the upper end 26 of the cartridge filter 12. In this configuration, substantially all of the cartridge filter 12 is in contact with fluids contained in the raw fluid chamber 20.

During operation, fluids flow into the filter system 10 through the inlet port 23 and into the raw fluid chamber 20. The fluids fill the raw fluid chamber and pass through the filter cartridge 16 and into the inner hollow core 68. The membrane forming the filter cartridge 16 removes materials from the fluid and allows at least a portion of the fluid to pass through the membrane. The type of materials removed from the fluid by the membrane may vary depending on the type of membrane used. After the fluids have reached the height of the inlet port 52 of the lift tube 16, the fluids flow into the lift tube 16 and collect in the processed fluid chamber 20. The processed fluids may be expelled from the tank 14 through the outlet port 25.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A fluid filter system, comprising:
a tank having a raw fluid chamber for receiving at least one cartridge filter;
an inlet port in the tank that provides access to the raw fluid chamber;
a cover releasably attached to the tank sealing the cavity;
a support plate having at least one aperture and positioned inside the tank proximate to a bottom wall of the tank that separates the tank into the raw fluid chamber and a processed fluid chamber;
an outlet port in the tank and in communication with the processed fluid chamber;
at least one lift tube releasably positioned in the at least one aperture in the support plate, extending upwardly from the support plate toward the cover, and having an inlet port proximate to an upper end of the at least one cartridge filter; and
the at least one cartridge filter positioned generally concentrically with the at least one lift tube;
wherein a fluid level in the tank is at a height of the inlet port in the at least one lift tube, which is in close proximity with a top level of the cartridge filter, during operation of the fluid filter system.

2. The fluid filter system of claim 1, further comprising an adapter attached to the support plate at the at least one aperture, wherein the at least one lift tube positioned in the adapter and forms a seal with the adapter.

3. The fluid filter system of claim 2, wherein the adapter is bell-shaped.

4. The fluid filter system of claim 1, wherein the support plate is positioned generally orthogonal to a longitudinal axis of the tank.

5. The fluid filter system of claim 1, wherein the inlet port in the tank is positioned proximate to the support plate in the raw fluid chamber.

6. The fluid filter system of claim 1, wherein the lift tube includes at least one protrusion extending from an outer surface of the lift tube that substantially seals the lift tube to the support plate.

7. The fluid filter system of claim 6, wherein the at least one protrusion is a collar extending around an outer surface of the lift tube.

8. The fluid filter system of claim 6, wherein the at least one protrusion extends sufficiently from the lift tube to enable the cartridge filter to be withdrawn from the raw water chamber together with the lift tube when the lift tube is withdrawn from the raw water chamber.

9. The fluid filter system of claim 1, wherein the at least one support plate comprises a plurality of apertures and a lift tube extending from each aperture.

10. The fluid filter system of claim 1, further comprising at least one cartridge sealing plate positioned in the raw fluid chamber for sealing the at least one cartridge in the tank.

11. The fluid filter system of claim 10, wherein the at least one cartridge sealing plate further comprises at least one plug extending from a bottom surface of the cartridge sealing plate for sealing the at least one cartridge in the tank.

12. The fluid filter system of claim 11, wherein the plug comprises a collar with a diameter greater than a diameter of a hollow core of the at least one cartridge filter.

13. The fluid filter system of claim 12, wherein the plug further comprises a dome adapted to fit within the hollow core of the at least one cartridge.

14. The fluid filter system of claim 10, wherein the at least one cartridge sealing plate is releasably attached to a rod so that the cartridge filter is compressed against the support plate and the at least one cartridge sealing plate.

15. A fluid filter system, comprising:
a tank having a raw fluid chamber for receiving at least one cartridge filter;
a support plate having a plurality of apertures and positioned inside the tank proximate to a bottom wall of the tank that separates the tank into the raw fluid chamber and a processed fluid chamber;
an adapter attached to the support plate at the at least one aperture;
an inlet port in the tank proximate to the support plate in the raw fluid chamber that provides access to the raw fluid chamber;
a cover releasably attached to the tank sealing the cavity;
an outlet port in the tank and in communication with the processed fluid chamber;
a lift tube releasably positioned in each open adapter in the apertures in the support plate, extending upwardly from the support plate toward the cover, and having an inlet port proximate to an upper end of the at least one cartridge filter;
a collar extending around an outer surface of the lift tube;
at least one cartridge filter positioned generally concentrically with the at least one lift tube;
at least one cartridge sealing plate positioned in the raw fluid chamber for sealing the at least one cartridge in the tank so that for fluids to pass through the fluid filter system, fluids must pass through filter material forming the at least one cartridge; and
wherein a fluid level in the tank is at a height of the inlet port in the at least one lift tube, which is in close proximity with a top level of the at least one cartridge filter, during operation of the fluid filter system.

16. The fluid filter system of claim 15, wherein the adapter is bell-shaped.

17. The fluid filter system of claim 15, wherein the support plate is positioned generally orthogonal to a longitudinal axis of the tank.

18. The fluid filter system of claim 15, wherein the collar of the lift tube extends from the lift tube to enable the cartridge filter to be withdrawn from the raw water chamber together with the lift tube when the lift tube is withdrawn from the raw water chamber.

19. The fluid filter system of claim 15, wherein the at least one cartridge sealing plate further comprises at least one plug extending from a bottom surface of the cartridge sealing plate for sealing the at least one cartridge to a bottom surface of the support plate.

20. The fluid filter system of claim 19, wherein the plug comprises a collar with a diameter greater than a diameter of a hollow core extending through the at least one cartridge and a dome adapted to fit within the hollow core of the at least one cartridge.

21. The fluid filter system of claim 15, wherein the at least one cartridge sealing plate is releasably attached to a rod extending generally parallel to the cartridge filter so that the cartridge filter is compressed against the support plate and the at least one cartridge sealing plate.

22. A fluid filter system, comprising:
a tank having a raw fluid chamber for receiving at least one cartridge filter;
a support plate having a plurality of apertures and positioned inside the tank proximate to a bottom wall of the tank that separates the tank into the raw fluid chamber and a processed fluid chamber;
an adapter attached to the support plate at the at least one aperture;
an inlet port in the tank proximate to the support plate in the raw fluid chamber that provides access to the raw fluid chamber;
a cover releasably attached to the tank sealing the cavity;
an outlet port in the tank and in communication with the processed fluid chamber;
a lift tube releasably positioned in each open adapter in the apertures in the support plate, extending upwardly from the support plate toward the cover, and having an inlet port proximate to an upper end of at least one cartridge filter;
the at least one cartridge filter positioned generally concentrically with the at least one lift tube;
a collar extending around an outer surface of the lift tube a distance sufficient to enable the cartridge filter to be withdrawn from the raw water chamber together with the lift tube when the lift tube is withdrawn from the raw water chamber;
at least one cartridge sealing plate positioned in the raw fluid chamber for sealing the at least one cartridge in the tank so that for fluids to pass through the fluid filter system, fluids must pass through filter material forming the at least one cartridge, wherein the at least one cartridge sealing plate includes at least one plug having a collar with a diameter greater than a diameter of a hollow core of the at least one cartridge and a dome adapted to fit within the hollow core of the at least one cartridge extends from a bottom surface of the cartridge sealing plate for sealing the at least one cartridge to a bottom surface of the support plate;
wherein a fluid level in the tank is at a height of the inlet port in the at least one lift tube, which is in close proximity with a top level of the cartridge filter, during operation of the fluid filter system; and
wherein the at least one cartridge sealing plate is releasably attached to a rod so that the cartridge filter is compressed against the support plate and the at least one cartridge sealing plate.
